(19) United States
(12) Patent Application Publication
(10) Pub. No.: US 2001/0029442 A1
(43) Pub. Date: Oct. 11, 2001

(54) Translation system, translation processing method and computer readable recording medium

(76) Inventors: Makoto Shiotsu, Inagi (JP); Akinari Masuyama, Kawasaki (JP); Fumiko Ito, Shibuya (JP); Koichi Koyaoka, Kawasaki (JP)

Correspondence Address: STAAS & HALSEY LLP, 700 11TH STREET, NW, SUITE 500, WASHINGTON, DC, 20001, US

(21) Appl. No.: 09/826,926

(22) Filed: Apr. 6, 2001

(30) Foreign Application Priority Data
Apr. 7, 2000 (JP) 2000-106557

(51) Int. Cl. G06F 17/28; G06F 17/27

(52) U.S. Cl. 704/4; 704/7; 704/2; 704/9

(57) ABSTRACT

A translation system having a translation receiving device that receives a source document to be translated, divides the source document into specified units of text, produces translation control information corresponding to the respective specified units and requests translation of the text. A translation device receives the text from the translation receiving device, and translates the text using the translation control information.

### CROSS REFERENCE TO RELATED APPLICATIONS

This application is based upon and claims priority of Japanese Patent Application No. 2000-106557, filed Apr. 7, 2000, the contents being incorporated herein by reference.

### BACKGROUND OF THE INVENTION

1. Field of the Invention

The present invention relates to a translation system to perform a machine translation operation. More particularly, the present invention is related to a translation system that determines translation options for one unit of text to be translated while another unit of text is being translated.

2. Description of the Related Art

The Internet is becoming more and more widespread, and overseas web sites and news distribution services relying on electronic mail have made it possible to easily obtain from overseas the latest news articles in many different fields. However, the news articles obtained from overseas via the Internet are generally written in a foreign language, not in a user's native language, making it difficult to grasp the content of those articles.

In order to solve the problem of translating foreign documents into one native language, machine translation is conventionally used to translate a source document from one language into a chosen target language.

When using a translating device to translate the above-described types of documents respectively containing news articles related to many different fields, a translation process is performed in which translation options are specified, such as grammatical information and dictionaries relevant to the fields of the sentences in the document.

The conventional translation process can be performed in two ways. The first way the conventional translation process can be performed involves a method in which a single translation device switches among translation options. The second way of performing the conventional translation process involves a method using several translation devices where different translation options are specified.

The conventional translation process using the method in which a single translation device switches among translation options is performed using an operation as shown in the flow chart of FIG. 1.

As shown in FIG. 1, first, a translation-requesting device requests that a translation-receiving device perform a translation process on a document to be translated (O100). The translation-receiving device receives the document to be translated with the translation request from the translation-requesting device, and splits the document into sentences based on separating characters in the document (O101).

After the document has been split into sentence units, the translation-receiving device seeks translation options (options 1) for translating a first sentence (sentence 1) and sets the translation options 1 (O102). After setting the translation options 1, the translation-receiving device requests that a translation device translate sentence 1 (O103). Next, the translation device receives sentence 1 from the translation-receiving device and runs a translation process on sentence 1 using the translation options 1 that were set for sentence 1 (O104). The translated sentence obtained during operation O104 is sent to the translation-receiving device as the translation result (O105).

After translating sentence 1, the translation-receiving device seeks translation options (options 2) in order to translate a second sentence (sentence 2) and sets the translation options 2 (O106). After the translation options 2 have been set, the translation-receiving device requests that the translation device translate sentence 2 (O107). Next, the translation device receives sentence 2 from the translation-receiving device and runs the translation process on sentence 2 using the translation options 2 that were set for sentence 2. The translated sentence obtained during operation O108 is sent to the translation-receiving device as the translation result (O109).

For each of the documents to be translated, the translation-receiving device sets the above-described translation options and performs the translation for each of the sentences contained in the document requested to be translated. The translation device performs the translation operation on the sentences for which translation is requested by the translation-receiving device using the predetermined translation options and sends those results to the translation-receiving device.

When the translation-receiving device receives the translation of the sentences contained in the document to be translated, the translation results are integrated with the format of the source document (O110) and the document is sent to the translation-requesting device as the translated result (O111).

The conventional translation process using the method in which several translation devices are used and different translation options are specified will now be described below with reference to the flow chart of FIG. 2.

As shown in FIG. 2, first, a translation-requesting device requests that the translation-receiving device perform the translation of a document (O200). The translation-receiving device receives the document to be translated with the translation request from the translation-requesting device, and splits the document to be translated into one-sentence units based on separating characters contained in the document (O201).

After the document has been split into one-sentence units, the translation-receiving device seeks translation options (options 1) to translate a first sentence (sentence 1) and sets the translation options 1 for the translation device 1 (O202). After the translation options 1 have been set, the translation-receiving device requests that a first translation device (translation device 1) translate sentence 1 (O203).

The translation-receiving device also seeks translation options (options 2) to translate the next sentence (sentence 2) and sets the translation options 2 for the translation device 2 (O204), and requests that the translation device 2 translate the sentence 2 (O206).

When the translation device 1 receives the translation request, it translates the sentence 1 based on the predetermined translation options 1 (O205). The translation device 2 translates the sentence 2 based on the predetermined translation options 2 (O207). When the translation device 1 and the translation device 2 complete their translations, they send the respective translation results to the translation-receiving device (O208, O209).

The translation-receiving device receives the respective translations of the sentences from translation device 1 and translation device 2 as the above operations are repeated for each of the sentences contained in the document to be translated. When all of the translated text of the document to be translated has been received, the translation-receiving device integrates the formatting of the source text with the translated text (O210), and sends the translation results of the document to the translation-requesting device (O211).

In operation of the conventional translation systems described above, when a single translation device is used to perform the translation process, the translation-receiving device switches the translation options and the translation device cannot perform processes during the time until the translation-receiving device requests that the translation device perform translation. That is, periods of time are created where the translation device does not function, resulting in inefficient use.

Furthermore, in operation of the conventional translation system shown in FIG. 1, the translation-receiving device is unable to set up any translation options for the next sentence until the translation device has completed the translation process, also resulting in inefficient use.

The conventional translation system shown in FIG. 2, which uses several translation devices, can switch among translation options and several translation devices can process translation requests, resulting in more efficient operation of the translation-receiving device than with the conventional device shown in FIG. 1.

However, in order to efficiently use the translation-receiving device shown in FIG. 2, several translation devices are required, which increases the overall cost of the system. Furthermore, when using a configuration having one device for multitasking processing to run several translation devices, the overall cost of the system can be kept down, but the translation process itself becomes quite burdensome so that an even greater processing burden is borne by the translation devices.

### SUMMARY OF THE INVENTION

The present invention provides a translation system, method and computer readable storage medium that solves the above-noted problems of the conventional translation systems and performs a translation operation using translation devices efficiently, with improved throughput and at low cost.

A translation system in accordance with embodiments of the present invention comprises a translation-receiving device to split a source document into sentences of specified units and combine the split up sentences with translation control information. A translation device receives each of the sentences from the translation-receiving device and translates the sentences using the translation control information corresponding to each sentence. The translation device sends the translated results of each of the sentences to the translation-receiving device. The translation-receiving device receives the translation results of the sentences and the sentences are integrated with the source document thereby generating a translated text.

In accordance with embodiments of the present invention, the translation system may comprise a single translation device, wherein a document to be translated is split into specific sized sentences combined with translation control information, and the translation operation is requested for each of the sentences. The sentences are translated by sequential conversion using the translation control information corresponding to each of the sentences.

Embodiments of the present invention may also be achieved with a translation system comprising several translation devices used for translation, wherein source text is split into sentences having a specific size, a translation request for the split sentences and the translation control information is sent to the translation-receiving device. When the translation device receives the sentences it uses the corresponding translation control information to produce the translation.

Moreover, in accordance with embodiments of the present invention, several source documents may be translated. The source documents are split into sentences and a translation process is requested for those sentences.

Embodiments of the present invention are achieved with a translation system wherein a translation request is made for a document containing document identifying information and sentence identifying information. The translated text is determined by integration based on the document identifying information and sentence identifying information contained in the translated results and the corresponding source text is kept distinct.

In accordance with embodiments of the present invention, a translation system comprises a translation receiving device that receives a source document to be translated, splits the source document into specified units of text, produces translation control information corresponding to the respective specified units and requests translation of the text. A translation device receives the text from the translation receiving device, and translates the text using the translation control information.

The translation device sends results of the translation of the units of text to the translation receiving device, and the translation receiving device receives the results of the translation of the respective units of text, and integrates the results of translation of the units of text to generate translated text of the source document.

The translation-receiving device may receive a plurality of source documents, split the respective source documents into units of text, and request the translation of the units of text of the source documents.

The translation receiving device may comprise document identifying information and sentence identifying information, and the translation receiving device integrates the translation results of the source document and distinguishes the source document based on the document identifying information, sentence identifying information and the translation results.

In accordance with embodiments of the present invention, a translation processing device comprises a splitting device splitting a document to be translated into sentences of specified units; a requesting device including translation control information, the requesting device requesting translation of the sentences and the translation control information; and a translation device sequentially translating the respective sentences with the corresponding translation control information.

Moreover, in accordance with embodiments of the present invention, a translation system comprises a splitting device splitting a source document into sentences of specified units; a translation receiving device comprising translation control information, the translation receiving device requesting the translation of the split sentences with the translation control information; and a plurality of translation devices respectively translating sentences using translation control information corresponding to each of the sentences received from the translation receiving device.

Embodiments of the present invention are achieved with a translation system, comprising a receiving device receiving a source text and translation control information corresponding to the source text; and a translation device translating the received source text by modifying the source text during translation using the translation control information corresponding to the source text.

Embodiments of the present invention are achieved with a computer readable storage medium storing a program for implementing a method of translating a document with a computer, the method comprising splitting the document to be translated into specified units of text; requesting translation of the units of text and corresponding translation control information; and sequentially translating the units of text based on the corresponding translation control information.

Embodiments of the present invention are achieved with a translation system, comprising a receiving device receiving a source text and translation control information corresponding to the source text; and a translation device translating the received source text by modifying the source text during translation using the translation control information corresponding to the source text.

Embodiments of the present invention are achieved a computer readable storage medium storing a program to implement a method of document translation with a computer, the method comprising receiving a source document and translation control information corresponding to the source document; and translating the received source document by modifying the source document during translation using the translation control information corresponding to the source document.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a flow chart illustrating a conventional translation operation.

FIG. 2 is a flow chart illustrating a conventional translation operation.

FIG. 3 is a block diagram of a translation system in accordance with embodiments of the present invention.

FIG. 4 is a flow chart of an operational process for performing a translation operation with a translation system in accordance with embodiments of the present invention.

FIG. 5 is a flow chart of an operational process for performing a translation operation with a translation system in accordance with embodiments of the present invention.

FIG. 6 is a diagram of translation options used in accordance with embodiments of the present invention.

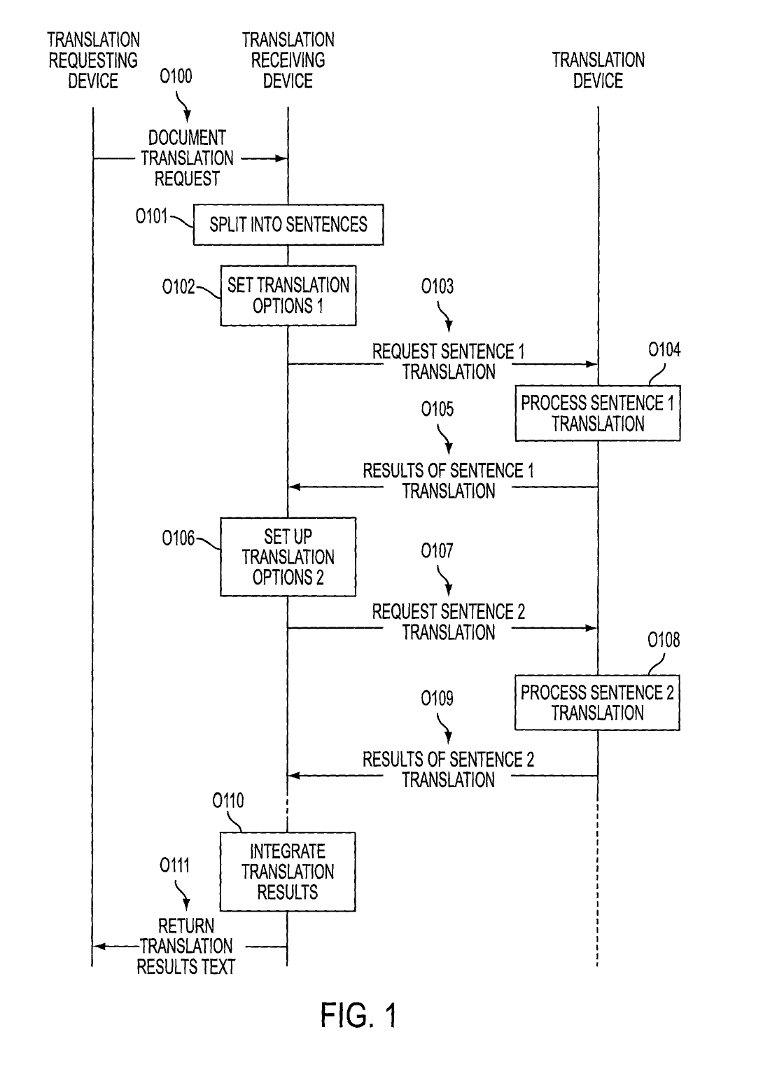

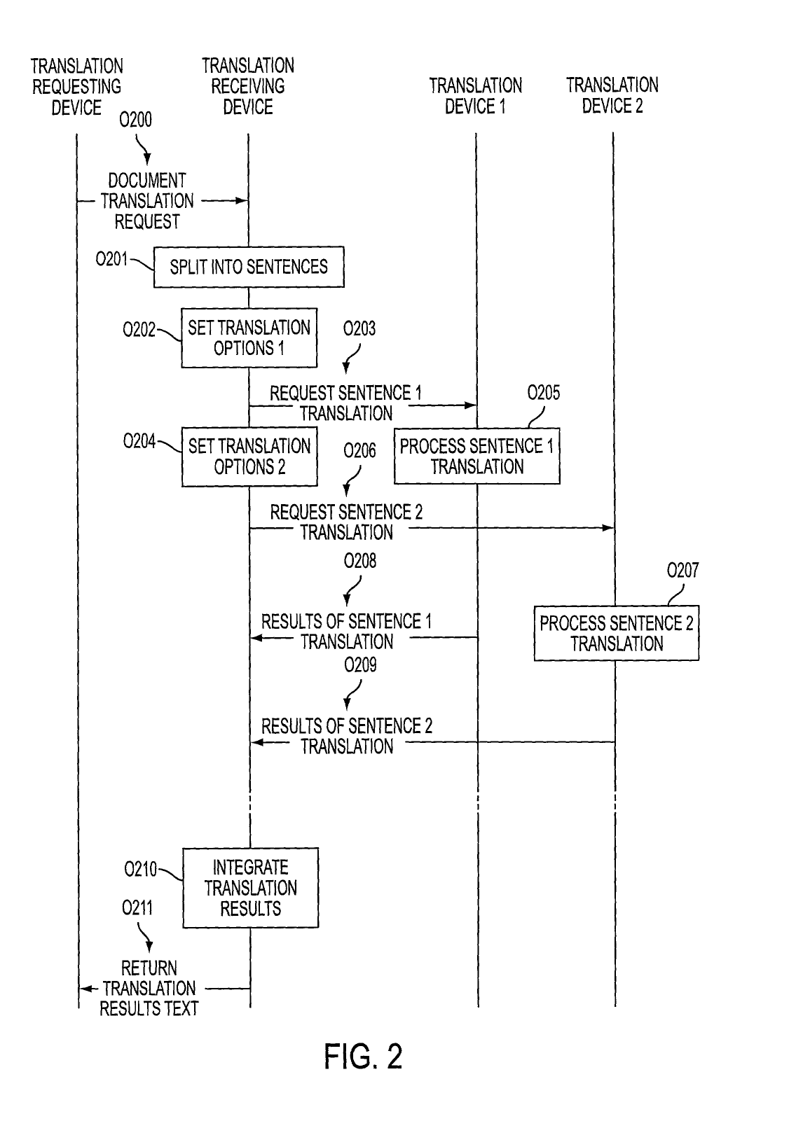

### DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

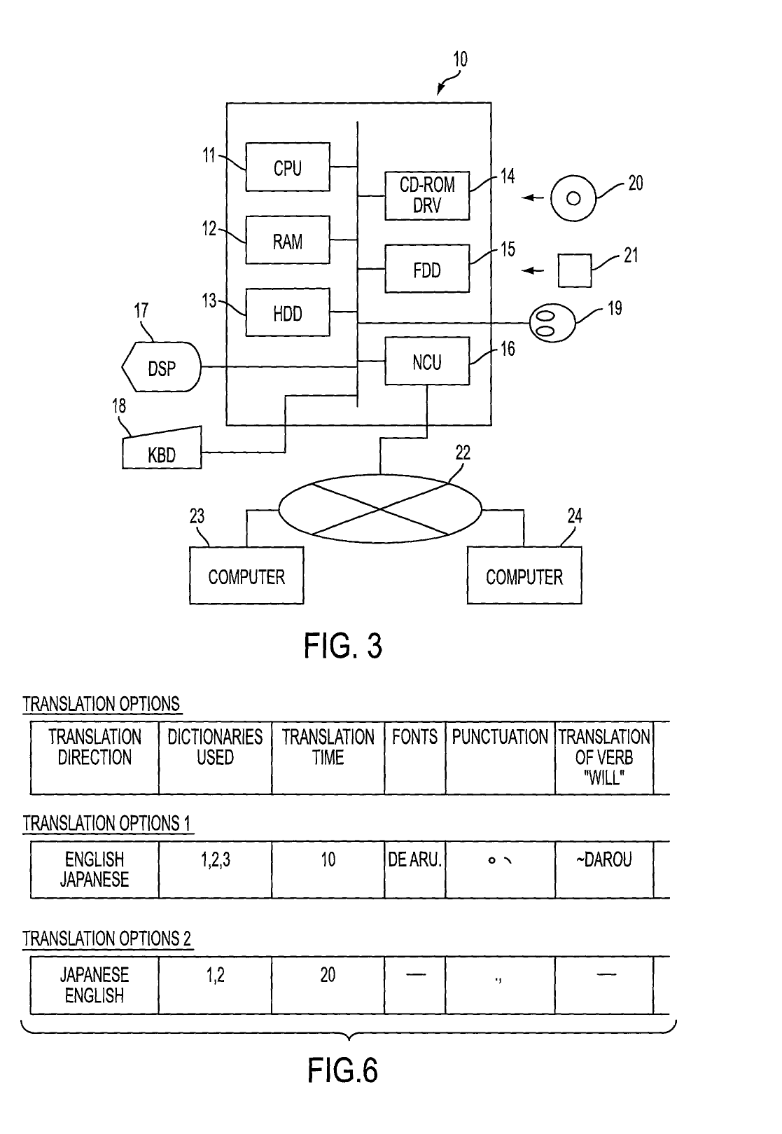

FIG. 3 is a block diagram of a translation system 10 in accordance with embodiments of the present invention. As shown in FIG. 3, the translation system 10 comprises a CPU 11, a RAM 12, a hard disk drive (HDD) 13, a CDROM drive 14, a floppy disk drive (FDD) 15, a network card, a modem and other communications control devices 16.

A graphics board (not shown in FIG. 3) is connected to a display 17, and a keyboard 18 and mouse 19 are connected by an interface (not shown in FIG. 3). Communications wires are connected to the communications control devices 16.

The RAM 12 stores a program that controls the translation system 10 and temporarily stores data for processing or processing results of the control program. The hard disk drive 13 and the floppy disk drive 15 respectively record data on hard disk or floppy disk 21 recording media. The CDROM drive 14 reads the program and data recorded on a CDROM 20.

The communications control devices 16 share data with other devices through communications lines and are used for downloading programs.

The keyboard 18 comprises letter keys and arrow keys and is used for all manner of data input. The mouse 19 operates a mouse cursor displayed on the screen of the display 17, and issues selection instructions using the mouse cursor.

The hard disk drive 13 stores a program used for implementing a translation operation with a computer. The program may be stored in advance on the hard disk drive 13 from the CDROM 20 or the floppy disk 21 using the CD ROM drive 14 or the floppy disk drive 15, respectively. The communications control devices 16 may also be used to store the program on the hard disk drive 13 via a network 22.

The program for implementing the translation operation is loaded into the RAM 12 in accordance with specific instructions. The program controls the various components of the translation system 10 and controls translation operations.

Other computers 23, 24 having the same hardware configuration as the translation system 10 may be connected to the network 22. The translation system 10 and computers 23 and 24 in combination with the program loaded into the RAM 12 can each operate as a translation requesting device 1, a translation receiving device 2 and a translation device 3. That is, the program loaded into RAM 12 controls the elements of the translation system 10 or computers 23, 24 shown in FIG. 3 to realize each of the functions described below.

In accordance with embodiments of the present invention, a document to be translated is received by the translation-receiving device 2 from the translation-requesting device 1. The translation device 3 translates sentences received from the translation-receiving device 2.

The translation-receiving device 2 includes, stored on the hard drive 13, translation control information for generating translation options for each of the sentences to be translated and sentence splitting information for splitting the document to be translated into one-sentence units.

The translation device 3 comprises, stored on the hard drive 13, dictionaries of grammatical analysis used in the analysis of parts of speech and a translation dictionary for language translation.

It is noted that the display 17, the keyboard 18 and the mouse 19 are not essential hardware for performing a translation operation in accordance with the present invention.

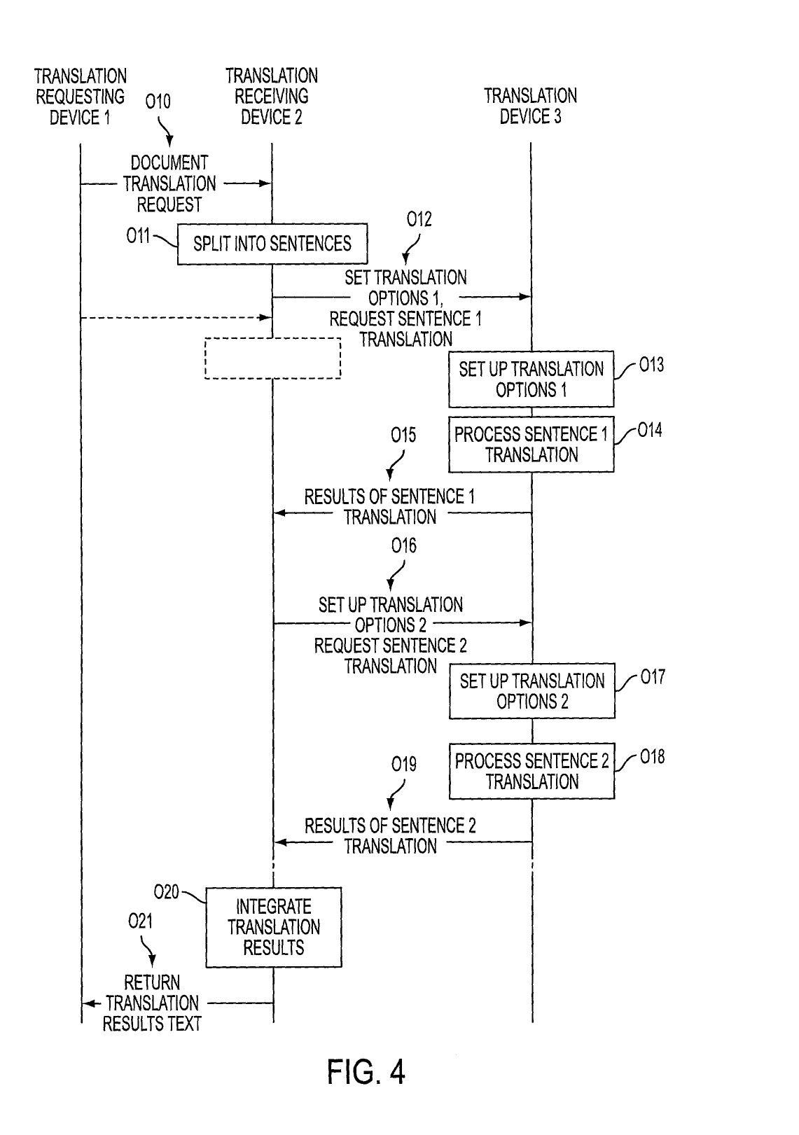

FIG. 4 is a flow chart illustrating an operational process for performing a translation operation with a translation system 10 in accordance with the present invention. In accordance with the embodiment shown in FIG. 4, a translation operation is executed with a single translation device 3.

As shown in FIG. 4, first, the translation-requesting device 1 sends a request to translate a document to the translation-receiving device 2 (O10). The translation-receiving device 2 splits the document to be translated received from the translation-requesting device 1 into one-sentence units using separating characters, such as punctuation and periods, contained in the document (O11).

After the document has been split into one-sentence units, the translation-receiving device 2 decides translation options (options 1) for the first sentence (sentence 1) to translate the sentence 1. The translation device 3 is requested to translate the sentence 1 with the options 1 (O12). The translation device 3 sets the translation options 1 received from the translation-receiving device 2 (O13), and the translation device 3 performs the translation operation on the sentence 1 based on those translation options 1 (O14). The translation-receiving device 2 receives the translated text of the sentence 1 from the translation device 3 (O15).

After requesting the translation of sentence 1, the translation-receiving device 2 decides translation options 2 for a next sentence (sentence 2) for translating the sentence 2. The translation-receiving device 2 then requests that the translation device 3 perform a translation of sentence 2 using the translation options 2 (O16). The translation device 3 performs the translation operation on sentence 2 after setting up the translation options 2 (O17, O18) and sends the translation results to the translation-receiving device 2 (O19).

The translation-receiving device 2 performs a translation request for each of the sentences contained in the document to be translated and the translation options corresponding to each of the sentences. The translation device 3 sets up the specified translation options and performs the translation operation on the sentences based on those translation options and repeatedly sends the results to the translation-receiving device 2.

When the translation-receiving device 2 receives the translated text of the sentences contained in the document to be translated, it integrates the translated text with the format of the source text (O20) and sends the translation results of the document to the translation requesting device 1 (O21).

The operational process described above with respect to FIG. 4 allows the translation device 3 to perform the translation operation constantly and the translation-receiving device 2 can seek the translation options for the next sentence to be translated while the translation operation is being performed by the translation device 3.

In the above-described manner, it is possible to efficiently operate the translation-receiving device 2 and the translation device 3.

An operation for translating a document with a translation system using several translation devices specifying different translation options in accordance with the present invention will now be described below.

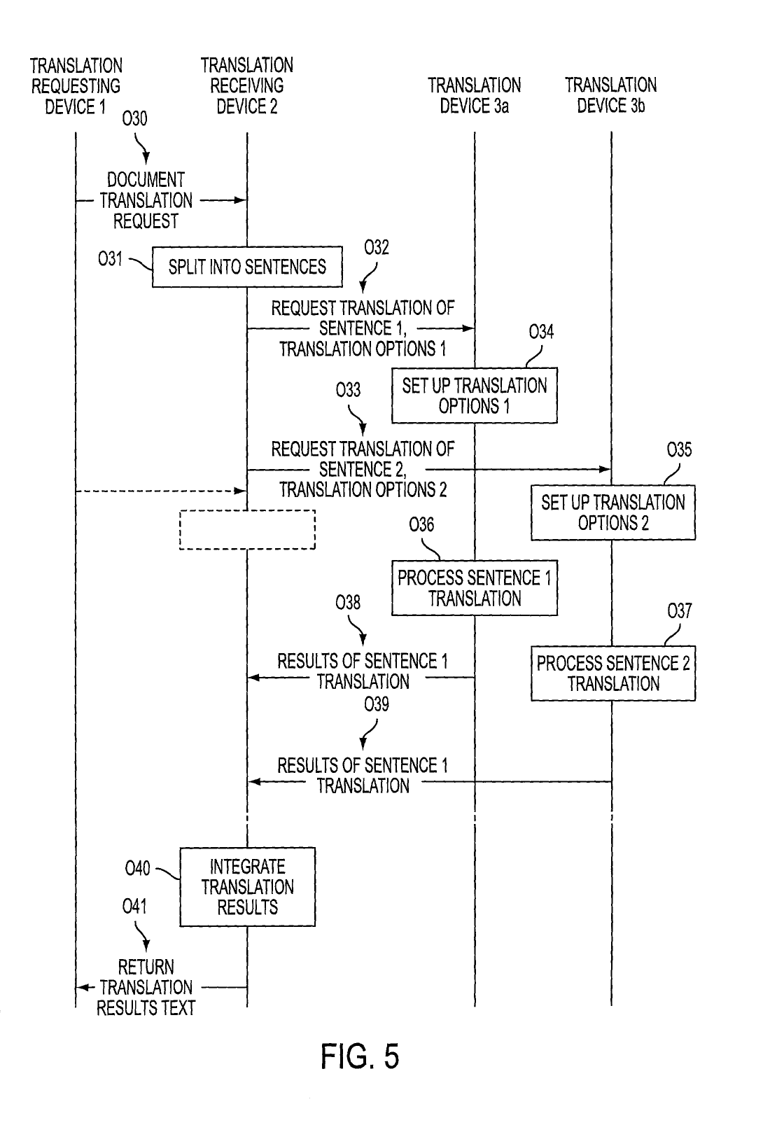

FIG. 5 is a flow chart of an operational process for translating a document with a translation system using several translation devices specifying different translation options in accordance with embodiments of the present invention.

As shown in FIG. 5, first, the translation-requesting device 1 requests that the translation-receiving device 2 perform a translation operation on the document to be translated (O30). The translation-receiving device 2 splits up the document to be translated into one-sentence units using separation characters (punctuation and periods) contained in the document received from the translation-requesting device 1 (O31).

After the document has been split into one-sentence units, the translation-receiving device 2 seeks translation options (options 1) for the first sentence (sentence 1) to be translated and requests that a translation device 3a translate sentence 1 with the translation options 1 (O32).

After requesting the translation of sentence 1, the translation-receiving device 2 seeks the translation options (options 2) for the second sentence (sentence 2) to translate the next sentence 2, and requests that a translation device 3b translate the sentence 2 with the translation options 2 (O33).

The translation device 3a sets up the translation options 1 received from the translation-receiving device 2 and performs the translation operation on sentence 1 based on the translation options 1 (O34, O36). Furthermore, the translation device 3b sets up the translation options 2 received from the translation-receiving device 2 and performs the translation operation on sentence 2 based on the translation options 2 (O35, O37).

The translation device 3a generates a translated text of sentence 1 using the translation operation and sends the translated text to the translation-receiving device 2 as the translation result (O38). The translation device 3b sends the translated text of sentence 2 generated as the translation result to the translation-receiving device 2 (O39).

The translation-receiving device 2 performs a translation request for each of the sentences and the translation options corresponding to those sentences contained in the document to be translated. The translation devices 3a and 3b set up the specified translation options and perform the translation operation based on those translation options. The translation devices 3a and 3b send the results to translation-receiving device 2 and repeat this operation.

When the translation-receiving device 2 receives the translated text of the sentences contained in the document to be translated, it integrates the translated texts with the formatting of the source document (O40) and sends the document to the translation-requesting device 1 as the translation result (O41).

In accordance with the embodiments of the invention shown in FIG. 5, the translation devices are efficiently controlled and the translation-receiving device 2 can seek the translation options for the next document to be translated while the translation device 3a or 3b is performing a translation operation.

In the manner described above, the translation-receiving device 2 and the translation device 3a, 3b can be used efficiently, and it is possible to realize better throughput than with the first embodiment.

The translation options used in the above-described translation operations will now be described below with reference to FIG. 6. As shown in FIG. 6, the translation options include categories such as translation direction, dictionaries used, translation time, fonts, punctuation and translation of the verb will.

The translation direction category of the translation options specifies the source language and target language. In the TRANSLATION OPTIONS 1 example shown in FIG. 6, the terms English Japanese indicate that the source language is English to be translated into Japanese. In the same manner, the terms Japanese English used in the TRANSLATION OPTIONS 2 example, indicate that the source language is Japanese to be translated into English. It will be recognized by those of ordinary skill in the relevant art that although the languages discussed in the embodiment shown in FIG. 6 are Japanese and English, many other source languages can be translated into many different target languages.

The DICTIONARIES USED category specifies the dictionaries to be used when performing the translation process. The dictionaries include the user dictionaries, specialized dictionaries and the like, and identifying information is set forth.

The category TRANSLATION TIME specifies a time limit for translation processing (in seconds). In the TRANSLATION OPTIONS 1 example, the time limit is 10 seconds, in the TRANSLATION OPTIONS 2 example, 20 seconds is the specified time limit.

The FONTS category specifies the font used in the English to Japanese translations. The PUNCTUATION category specifies what to use for punctuation in the translated text. In the TRANSLATION OPTIONS 1 example, the punctuation used are “ [symbol] ” and “ [symbol] ” (period and comma). In the TRANSLATION OPTIONS 2 example, the punctuation used are the period (“.”) and the comma (“,”).

The “TRANSLATION OF VERB WILL” category is used to specify how the word “will” will be translated in Japanese to English translation.

The translation-receiving device 2 decides each of the translation option categories in the manner described below.

In order to decide the translation options and words (keywords), the translation-receiving device 2 comprises a database which draws correlations between information which is provided to the database in advance for the purpose of judging the language in which the sentences are written. The technique for distinguishing the language in which a sentence is written is well known, and a description of that technique is omitted.

For example, the translation receiving device may store information in the database as in the following examples.

### EXAMPLE 1

Keywords: News, economics

Dictionary: Finance, Economic Dictionaries

Translation Direction: Japanese English

### EXAMPLE 2

Keywords: Computer

Dictionary: Information Processing, User Dictionary 1

Translation Direction: English Japanese

The translation-receiving device 2 splits the document received from the translation-requesting device 1 into one-sentence units and extracts the words contained in each of those sentences. The above databases are searched using the extracted words, and the settings of each of the translation option categories are sought.

In accordance with embodiments of the present invention, the database contains the translation direction. However, alternatively, the translation-requesting device 1 can send a translation request to the translation-receiving device 2 which specifies the translation direction, and the translation-receiving device 2 sets the specified translation direction as a translation option.

The translation device 3 receives the source text from the translation-receiving device 2 and generates a translated text based on the specified translation option categories.

In accordance with the embodiments of the present invention described hereinabove, the translation system was described as comprising separate devices, specifically, the translation-requesting device 1, the translation-receiving device 2 and the translation device 3 (3a and 3b). The data flow between these devices in different systems can be realized through various known technologies, including message communications and electronic mail.

However, the present invention is not limited to a separate translation-requesting device 1, translation receiving device 2 and translation device 3. More specifically, the translation-receiving device 2 and the translation device 3 (3a and 3b) may be configured as a single device with tasks performed in series or using a multitasking process. In this case, the translation-receiving device 2 and translation device 3 (3a and 3b) may be configured as modules running programs for the respective functions. The configuration could be run using a single device and a number of modules for performing the translation operation. Communications between these modules can be performed using known methods of message communications or another known method of sending data.

Whether the translation system is comprised of several independent devices or a single device, the translation request from the translation-receiving device 2 to the translation device 3 (3a and 3b) contains numerical identifying information, including a document ID, which specifies the document as well as the type of sentences in the document. The translation device 3 (3a and 3b) adds the identifying information and sends the translated text to the translation-receiving device 2.

The translation-receiving device 2 can determine whether or not the entire translated text has been received based on the identifying information added to the translated text. The identifying information can also be used to judge the correspondence between the source text and the translated text, and the text of the translation results derived from the translated text can be generated in the format of the source text.

The translation-receiving device 2 can also receive several documents to be translated. Along with sending a translation request to the translation device 3 (3a and 3b) for a particular document, the translation-receiving device 2 can also split another document into one-sentence units and send a translation request to the translation device 3 (3a and 3b) in parallel.

In accordance with embodiments of the invention described herein above, it is assumed that there are several pre-existing translation devices 3. However, it is possible to generate a new translation device 3 (3a and 3b) in response to a translation request from the translation-receiving device 2.

For example, the translation operation could be performed in the following manner. The translation device 3 may include a control module and a translation process module, and during the translation operation by the translation device 3a, which is a translation processing module, the control module receives a translation request from the translation-receiving device 2. A new translation device 3b, which is a new translation processing module, is generated to perform the translation operation in parallel. Parallel processing is possible through the use of known multitask processing or multithread processing. In this case, the translation-receiving device 2 responds to the translation state of the translation device 3 and manages and executes the translation requests to the translation device 3. This configuration further improves both the translation processing efficiency and throughput.

As described above, the present invention provides a more efficient translation processing while decreasing costs when using a single translation device for the translation process of this invention. Further, the present invention provides more efficient translation processing using more than one translation device and to improve throughput.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A translation system, comprising:
a translation receiving device receiving a source document to be translated, splitting the source document into specified units of text, producing translation control information corresponding to the respective specified units and requesting translation of the text; and
a translation device receiving the text from the translation receiving device, and translating the text using the translation control information.

2. A translation system as recited in claim 1, wherein the translation device sends results of the translation of the units of text to the translation receiving device, and
the translation receiving device receives the results of the translation of the respective units of text, and integrates the results of translation of the units of text to generate translated text of the source document.

3. A translation system as recited in claim 1, wherein the translation-receiving device receives a plurality of source documents, splits the respective source documents into units of text, and requests the translation of the units of text of the source documents.

4. A translation system as recited in claim 2, wherein the translation receiving device comprises document identifying information and sentence identifying information, and the translation receiving device integrates the translation results of the source document and distinguishes the source document based on the document identifying information, sentence identifying information and the translation results.

5. A translation processing device, comprising:
a splitting device splitting a document to be translated into sentences of specified units;
a requesting device including translation control information, the requesting device requesting translation of the sentences and the translation control information; and
a translation device sequentially translating the respective sentences with the translation control information.

6. A translation system, comprising:
a splitting device splitting a source document into sentences of specified units;
a translation receiving device comprising translation control information, the translation requesting device requesting the translation of the split sentences with the translation control information; and
a plurality of translation devices respectively translating sentences using translation control information corresponding to each of the sentences received from the translation receiving device.

7. A computer readable storage medium storing a program for implementing a method of translating a document with a computer, the method comprising:
splitting the document to be translated into specified units of text;
requesting translation of the units of text and corresponding translation control information; and
sequentially translating the units of text based on the corresponding translation control information.

8. A translation system, comprising:
a receiving device receiving a source text and translation control information corresponding to the source text; and
a translation device translating the received source text by modifying the source text during translation using the translation control information corresponding to the source text.

9. A computer readable storage medium storing a program to implement a method of document translation with a computer, the method comprising:
receiving a source document and translation control information corresponding to the source document; and
translating the received source document by modifying the source document during translation using the translation control information corresponding to the source document.

10. A translation processing system, comprising:
splitting means for splitting a document to be translated into specified units of text;
requesting means, including translation control information, for requesting translation of the respective units of text and the translation control information; and
translation means for sequentially translating the respective units of text with the translation control information.

11. A translation processing system as recited in claim 10, wherein the translation means comprises a plurality of translation means respectively translating sentences using translation control information corresponding to each of the sentences received from the translation receiving device.

12. A translation system, comprising:
a translation requesting device including text to be translated, the requesting device communicating the text to be translated and a translation request;
a splitting device receiving the text to be translated and splitting the text to be translated into separate units of text based on splitting information stored therein;
an options seeking device seeking translation options corresponding to the separate units of text, the options seeking device including translation control information used to generate the translation options;
a translation device receiving the separate units of text from the splitting device and the corresponding translation options from the options seeking device and translating the separate units of text based on the corresponding translation options; and
an integrating device receiving the translated separate units of text and integrating the translated separate units of text into a translated text.

13. A translation system as recited in claim 12, wherein the translation device comprises a plurality of translation devices respectively receiving and translating the separate units of text.

14. A translation system as recited in claim 12, wherein the options seeking device seeks translation options for a next unit of text to be translated while a previous unit of text is being translated.

15. A translation system as recited in claim 13, wherein the options seeking device seeks translation options for a next unit of text to be translated while a previous unit of text is being translated by any one of the plurality of translation devices.

16. A translation system as recited in claim 13, wherein the t ext to be translated comprises separate documents and the plurality of translation devices translate the separate documents in parallel.
